(19) United States
(12) Patent Application Publication
(10) Pub. No.: US 2022/0067139 A1
(43) Pub. Date: Mar. 3, 2022

(54) LOSS PREVENTION OF DEVICES

(71) Applicant: KYNDRYL, INC., New York, NY (US)

(72) Inventors: Cesar Augusto Rodriguez Bravo, Alajuela (CR); Kevin Jimenez Mendez, Heredia (CR); Romelia H. Flores, Keller, TX (US); David Lee, Round Rock, TX (US)

(21) Appl. No.: 17/001,943

(22) Filed: Aug. 25, 2020

(51) Int. Cl. G06F 21/44; G06F 9/4401; G06F 21/57; G06F 21/60

(52) U.S. Cl. CPC G06F 21/44; G06F 9/4406; G06F 2221/034; G06F 21/602; G06F 21/575

(57) ABSTRACT

Embodiments of the present invention disclose solutions that receive a request to boot up an operating system of a computing device and determine whether a hardware component of the computing device is valid. Embodiments of the present invention can also be used to, in response to determining that the hardware component of the computing device is not valid, perform one or more security measures.

### BACKGROUND

The present invention relates to the field of digital computer systems, and more specifically, to improving digital computer systems by securing digital devices.

Mobile security of mobile computing devices are typically at risk to exploits inherent in these computing devices. These devices compile an increasing amount of sensitive information. Typically attacks on these devices exploit weaknesses inherent in digital devices (e.g., smartphones) that can come from the communication mode—like Short Message Service (SMS, aka text messaging), Multimedia Messaging Service (MMS), WiFi®, Bluetooth®, and GSM, the de facto global standard for mobile communications. There are also exploits that target software vulnerabilities in the browser or operating system.

Typical countermeasures can provide security in different layers of software to prevent unauthorized access. Countermeasures are divided into different categories that are typically associated with the areas they seek to improve. For example, countermeasures can range from the management of security by the operating system to the behavioral education of the user.

### SUMMARY

Various embodiments provide a method computer system and computer program product as described by the subject matter of the independent claims. Advantageous embodiments are described in the dependent claims. Embodiments of the present invention can be freely combined with each other if they are not mutually exclusive.

Embodiments of the present invention provide a computer-implemented method, computer program products, and computer systems. For example, in one embodiment of the present invention, a computer-implemented method is provided, comprising: receive a request to boot up an operating system of a computing device; program instructions to determine whether a hardware component of the computing device is valid; and program instructions to, in response to determining that the hardware component of the computing device is not valid, perform one or more security measures.

### BRIEF DESCRIPTION OF THE DRAWINGS

FIG. 1 is a functional block diagram illustrating a computing environment, in accordance with an embodiment of the present invention;

FIG. 2 is a flowchart depicting operational steps for performing a security measure based on hardware verification, in accordance with an embodiment of the present invention;

FIG. 3 is a flowchart depicting operational steps for validating a hardware component and encrypting data, in accordance with an embodiment of the present invention; and

FIG. 4 depicts a block diagram of components of the computing systems of FIG. 1, in accordance with an embodiment of the present invention.

### DETAILED DESCRIPTION

Embodiments of the present invention recognize deficiencies mobile device security measures. Specifically, embodiments of the present invention recognize that traditional security measures when a device is lost rely on an authentication mechanism relying on software that can be compromised. Some security measures can be overridden by replacing hardware (e.g., a battery of the device). Embodiments of the present invention help improve mobile device security measures when hardware is replaced. In other words, embodiments of the present invention provide solutions for increasing security of a mobile device when hardware of the mobile device is replaced in an effort to circumvent the mobile device's security measures. Specifically, embodiments of the present invention can be used to validate a mobile device's battery and prevent use of the mobile device by preventing boot up of the operating system of the mobile device in response to a failed, off-line authentication of the battery as discussed in greater detail later in this Specification. Certain other embodiments can provide additional security measures by encrypting data while the system validates the mobile device's battery.

As used herein, a computing device (also referred to as a mobile device) can be a laptop computer, a tablet computer, a netbook computer, a personal computer (PC), a desktop computer, a personal digital assistance (PDA), a smart phone, or any programmable electronic device capable of communicating with various components and other computing devices. Embodiments of the present invention provide mechanisms for a user to opt-in and opt-out of data collection events (e.g., user information and/or location information) and can, in some instances, transmit a notification that user information is being collected or otherwise being accessed and used. As used herein “user information” refers to information associated with a user and can be found in a user's profile, user preferences, display settings, device information, etc. In this embodiment, “location information” refers to information about a location and changes to information pertaining to navigation to and from the location. For example, location information can refer to position information of a device. Position information refers to directional information or changes in directional information that includes device location. Positional information can also include information surrounding an area of the device.

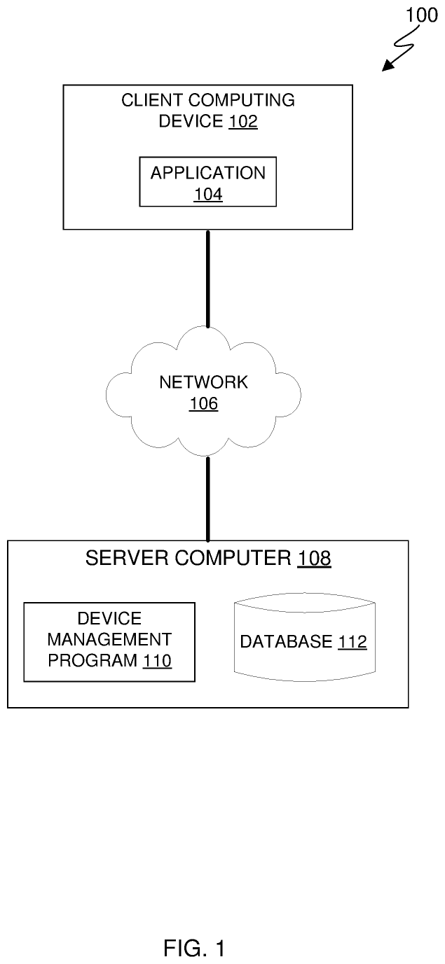

FIG. 1 is a functional block diagram illustrating a computing environment, generally designated, computing environment 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

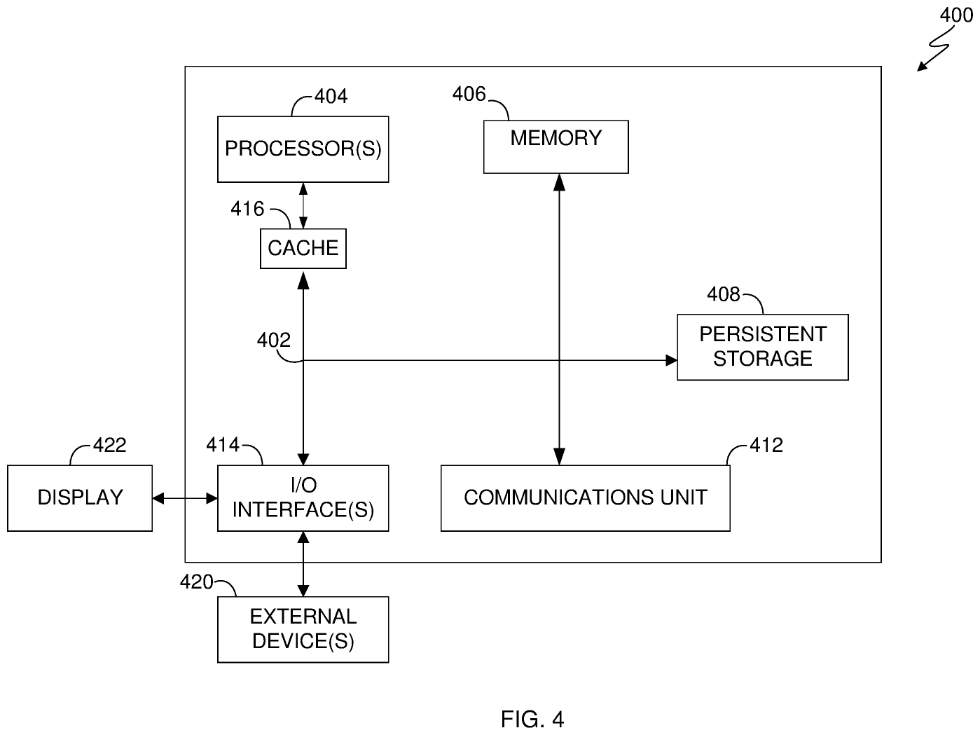

Computing environment 100 includes client computing device 102 and server computer 108, all interconnected over network 106. Client computing device 102 and server computer 108 can be a standalone computer device, a management server, a webserver, a mobile computing device, or any other electronic device or computing system capable of receiving, sending, and processing data. In other embodiments, client computing device 102 and server computer 108 can represent a server computing system utilizing multiple computer as a server system, such as in a cloud computing environment. In another embodiment, client computing device 102 and server computer 108 can be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, client computing device 102 and server computer 108 each represent a computing system utilizing clustered computers and components (e.g., database server computers, application server computers, etc.) that act as a single pool of seamless resources when accessed within computing environment 100. In some embodiments, client computing device 102 and server computer 108 are a single device. Client computing device 102 and server computer 108 may include internal and external hardware components capable of executing machine-readable program instructions, as depicted and described in further detail with respect to FIG. 4.

Client computing device 102 is a digital device associated with a user and includes application 104. Application 104 communicates with server computer 108 to access device management program 110 (e.g., using TCP/IP) to access device information. As used herein, device information refers to any hardware and/or software currently installed on or registered with the device. For example, device information can include information regarding hardware components registered to or otherwise paired with the device (e.g., one or more processors, memory, communications units, power sources such as batteries, etc.). Device information can further include any currently installed software on the device such as an operating system and one or more applications. In certain other embodiments application 104 can also communicate with server computer 108 to obtain user information.

Application 104 can further communicate with device management program 110 to transmit instructions to validate device hardware (e.g., a battery) by identifying device information and verifying whether hardware installed on the device is registered to the device. In response to an unsuccessful verification (i.e., authentication), application 104 can disable the mobile device. For example, application 104 can cut power to the mobile device and prevent the mobile device from booting its operating system. In other embodiments application 104 can receive instructions from device management program 110 to not power or otherwise not access or utilize the unverified hardware component.

In certain embodiments, application 104 can further communicate with device management program 110 to determine the presence or absence of sensitive information. “Sensitive information” or “sensitive data” as used herein, refers to data pertaining to the user that is created, entered, and/or stored while using an application or device. Sensitive information can include information pertaining to a user's racial or ethnic origin, political opinions, religious beliefs, membership to an organization, physical, mental or health condition, sexual life, commission or alleged commission of any offense. Sensitive data include, but is not limited to, contact information, pictures, audio, or any other configurable data types that a person can store data in that an application can access. In general, application 104 can be implemented using a browser and web portal or any program that can interface with or otherwise access device management program 110.

Network 106 can be, for example, a telecommunications network, a local area network (LAN), a wide area network (WAN), such as the Internet, or a combination of the three, and can include wired, wireless, or fiber optic connections. Network 106 can include one or more wired and/or wireless networks that are capable of receiving and transmitting data, voice, and/or video signals, including multimedia signals that include voice, data, and video information. In general, network 106 can be any combination of connections and protocols that will support communications among client computing device 102 and server computer 108, and other computing devices (not shown) within computing environment 100.

Server computer 108 is a digital device that hosts device management program 110 and database 112. In this embodiment, database 112 functions as a repository for stored content. Database 112 can reside on a cloud infrastructure and stores user generated information. In some embodiments, database 112 can function as a repository for one or more files containing user information. Database 112 can further store device information. In this embodiment, database 112 is stored on server computer 108 however, database 112 can be stored on a combination of other computing devices (not shown) and/or one or more components of computing environment 100 (e.g., client computing device 102) and/or other databases that has given permission access to device management program 110.

In general, database 112 can be implemented using any non-volatile storage media known in the art. For example, database 112 can be implemented with a tape library, optical library, one or more independent hard disk drives, or multiple hard disk drives in a redundant array of independent disk (RAID). In this embodiment database 112 is stored on server computer 108.

In this embodiment, device management program 110 resides on server computer 108. In other embodiments, device management program 110 can have an instance of the program (not shown) stored locally on client computer device 102. In yet other embodiments, device management program 110 can be stored on any number or computing devices (e.g., a smart device).

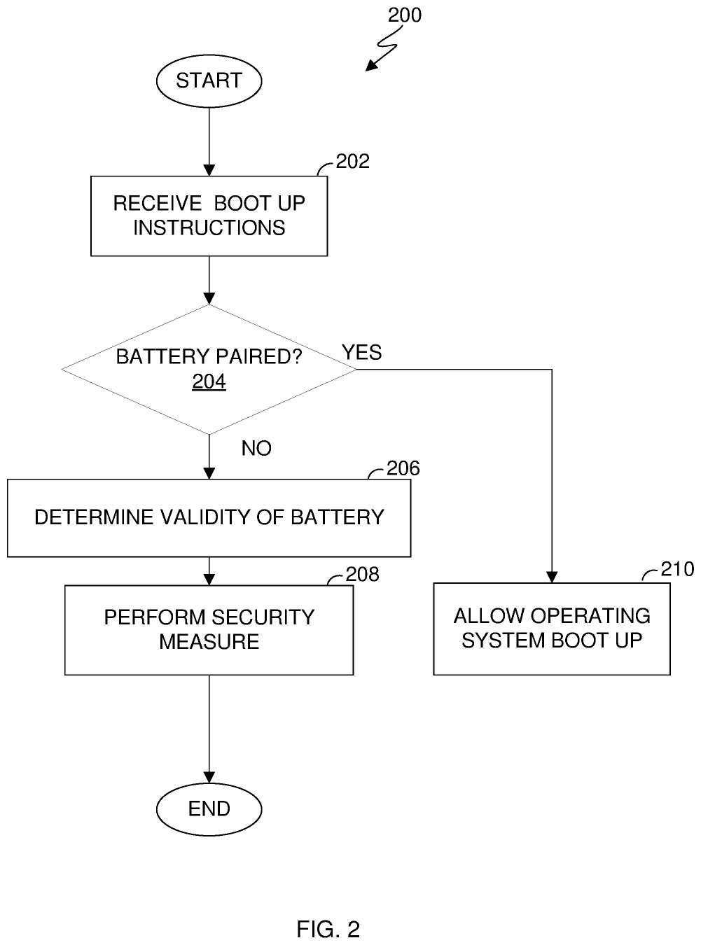

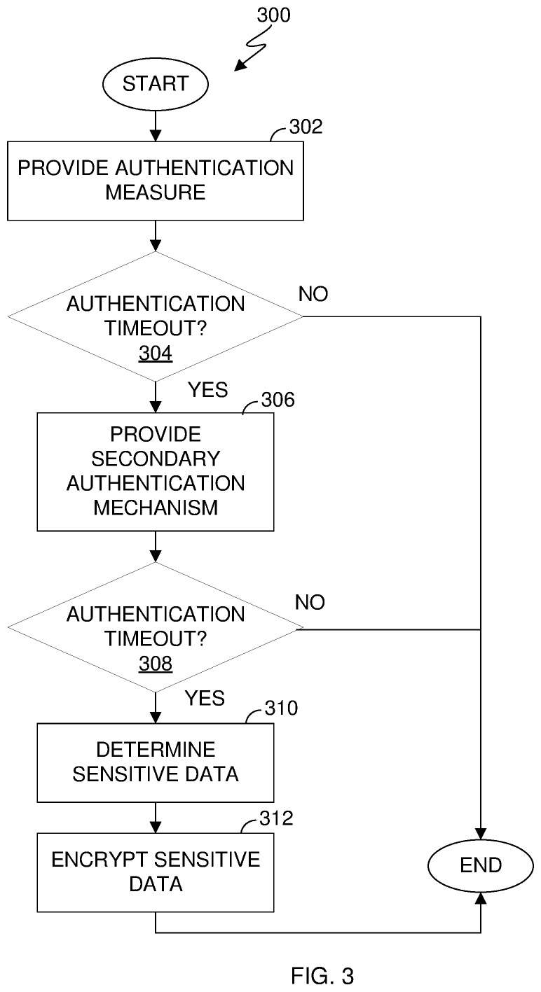

In instances where device management program 110 resides on client computing device 102, device management program 110 can validate hardware and software components of a computing device locally, that is, without the need to connect to a network. In this embodiment, device management program 110 can validate device hardware (e.g., a battery) by identifying device information and verifying whether hardware installed on the device is registered to the device within a predetermined time period as discussed in greater detail with regard to FIGS. 2 and 3.

In response to an unsuccessful verification (i.e., authentication) of a hardware component of the device, device management program 110 can disable the mobile device. In this embodiment, device management program 110 can disable a mobile device by blocking ports that would access power to the hardware component. For example, if the hardware component is a battery and device management program 110 is unable to validate the battery, device management program 110 can prevent the device from drawing power from the battery. In this example, device management program 110 can further prevent the device from allowing the battery to be charged. Device management program 110 can then transmit a message to the device's registered user that includes location information and take other ameliorative actions. In some embodiments, device management program 110 can notify authorities as to the location of the device. In certain other embodiments device management program 110 can access camera functionality of a phone and take a picture of a person trying to access the device and subsequently transmit the captured image to the registered user of the device. In yet other embodiments, device management program 110 can be configured to erase all data contained in the device in response to an unsuccessful verification.

In certain embodiments, device management program 110 can, in response to an unsuccessful verification, execute a backup recovery method (i.e., a secondary validation/verification method). In this embodiment, a secondary verification can include traditional password authentication measures to validate a user trying to access the device. In these instances, in response to a successful secondary validation, device management program 110 can optionally display pairing instructions for a newly installed battery (i.e., that was not previously paired with the device). For example, device management program 110 fails to validate the hardware component (e.g., a battery) as not being paired with the device. Device management program 110 can then provide a secondary verification to validate a user accessing the device as the registered user of the device (e.g., via a traditional authentication mechanism). In response to a successful secondary validation, device management program 110 can then display pairing instructions for the newly installed hardware with the device. Device management program 110 can then allow or otherwise execute the operating system boot up process.

In instances where device management program 110 resides on a server computer, device management program 110 can communicate with application 104 to disable the mobile device in response to an unsuccessful verification (i.e., authentication). In this embodiment, device management program 110 can disable a mobile device by transmitting instructions to application 104 to block ports that would access power to the hardware component. Device management program 110 can then prevent the device from drawing power from the battery or conversely prevent the battery from being charged, as discussed above.

Regardless of where device management program 110 resides, device management program 110 can also determine whether sensitive data is stored on a computing device and encrypt the sensitive data during a hardware component validation (i.e., verification). In some instances where, device management program 110 is stored locally on the device, device management program 110 can encrypt the sensitive data after an unsuccessful verification by drawing power from a power source and generating a false boot up screen while preventing the execution of the actual operating system bootup. In this embodiment, device management program 110 can encrypt sensitive data using a random key. In other embodiments, device management program 110 can be configured to encrypt all data stored on the device.

FIG. 2 is a flowchart 200 depicting operational steps for performing a security measure based on hardware verification, in accordance with an embodiment of the present invention. In this embodiment, the flowchart uses a battery as the hardware component, however, it should be understood that the operational steps of flowchart 200 can be implemented for one or more other hardware components. Further, in this embodiment, device management program 110 is stored locally on a computing device (e.g., client computing device 102), however, it should be understood that device management program can be stored on any number of devices and/or components of computing environment 100.

In step 202, device management program 110 receives boot up instructions. In this embodiment, device management program 110 receives boot up instructions from one or more components of client computing device 102. For example, device management program 110 can receive boot up instructions from application 104.

In step 204, device management program 110 determines whether the battery is paired with the device. In this embodiment, device management program 110 determines that a battery is paired with the device by identifying the battery's serial number and comparing it to a registered battery serial number (e.g., a paired serial number with the device). In certain instances, device management program 110 can provide pairing instructions to register a new hardware component (e.g., the battery).

If, in step 204, device management program 110 determines that the battery is not paired with the device, then, in step 206, device management program 110 determines the validity of the battery. In this embodiment, device management program 110 determines the validity of the battery by identifying the battery's serial number and providing an authentication measure for a specified time period, as discussed in greater detail with regard to flowchart 300 in FIG. 3. Device management program 110 can further determine whether sensitive data is stored on the device and, in response to determine that there is sensitive data stored on the device, device management program 110 can encrypt the data.

If, in step 204, device management program 110 determines that the battery is paired with the device, then, in step 210, device management program 110 allows the device's operating system to boot up. In other words, device management program 110 allows normal processing to resume.

In step 208, device management program 110 performs a security measure. In this embodiment, device management program 110 performs a security measure by providing an authentication mechanism to authenticate a user trying to access the device. In instances where there is an unsuccessful authentication, device management program 110 can perform a number of additional security measures. In this embodiment, a security measure can include preventing the device from drawing power from or otherwise accessing ports connected to the hardware component (e.g., preventing the device from drawing power from the battery). Device management program 110 can further prevent the device from allowing the battery to be charged. Another example of a security measure that device management program 110 can perform includes transmitting a message to the device's registered user that includes location information. For example, device management program 110 can mark a device's location on a map and transmit a message that contains that location information. Other security measures and/or ameliorative actions can include notifying authorities as to the location of the device. In certain other embodiments device management program 110 can access camera functionality of a phone and take a picture of a person trying to access the device and subsequently transmit the captured image to the registered user of the device. In yet other embodiments, device management program 110 can be configured to erase and/or encrypt either sensitive data or all data contained in the device in response to an unsuccessful verification.

FIG. 3 is a flowchart 300 depicting operational steps for validating a hardware component and encrypting data, in accordance with an embodiment of the present invention. In this embodiment, the flowchart uses a battery as the hardware component, however, it should be understood that the operational steps of flowchart 200 can be implemented for one or more other hardware components. Further, in this embodiment, device management program 110 is stored locally on a computing device (e.g., client computing device 102), however, it should be understood that device management program can be stored on any number of devices and/or components of computing environment 100.

In step 302, device management program 110 provides an authentication measure. In this embodiment, device management program 110 provides an authentication measure that includes one or more traditional authentication measures to validate a user trying to access the device. For example, if the device includes facial recognition or biometric authentication, device management program 110 can access and provide the biometric authentication measure. In other embodiments, device management program 110 can provide a traditional password authentication measure that can authenticate correct alphanumeric text input and conversely determine an incorrect alphanumeric text input. In yet other embodiments, device management program 110 can include any combination of authentication measures (e.g., two-factor authentication) known in the art.

In step 304, device management program 110 determines whether the authentication measure timed out. In this embodiment, device management program 110 determines whether the authentication measure timed out by measuring starting a time period when the authentication measure is provided and stopping the measured time period at a predetermined, configurable threshold. For example, device management program 110 can access database 112 to identify a user configured threshold of one minute for an authentication measure. In other embodiments, the predetermined, configurable threshold can be any measurable time period.

In this embodiment, device management program 110 determines the authentication time out when the time defined period for allowing the authentication measure expires (i.e., when an authentication period is met). In this embodiment, device management program 110 determines an unsuccessful authentication measure when the authentication measure times out, that is, device management program 110 identifies an unsuccessful authentication attempt when the time period for authentication expires. Conversely, device management program 110 determines a successful authentication measure if device management program 110 receives and is able to process a positive authentication input (e.g., a correct password) within the time period.

If, in step 304, device management program 110 determines that the authentication measure timed out, then in step 306, device management program 110 provides a secondary authentication mechanism. As mentioned earlier, a secondary verification can include traditional password authentication measures and/or one or more biometric authentication measures to validate a user trying to access the device.

If, in step 304, device management program 110 determines that the authentication measure did not time out and there was a positive authentication has occurred within the time period (i.e., that a correct password or successful biometric scan was entered), then processing ends. In this embodiment, device management program 110 can then display pairing instructions for the newly installed hardware with the device. Device management program 110 can then allow or otherwise execute the operating system boot up process as discussed earlier in step 210 of flowchart 200.

In step 308, device management program 110 determines whether the authentication measure timed out. In this embodiment, device management program 100 determines whether the authentication measure timed out by measuring starting a time period when the authentication measure is provided and stopping the measured time period at a predetermined, configurable threshold, as previously discussed with regard to step 304. In this embodiment, the “time out” period can be the same as in step 304. In other embodiments, the time out period can be any configurable length of time.

If, in step 308, device management program 110 determines that the authentication did not time out, then, device management program 110 can optionally display pairing instructions for a newly installed battery (i.e., that was not previously paired with the device) then processing ends. In this embodiment, device management program 110 can then display pairing instructions for the newly installed hardware with the device. Device management program 110 can then allow or otherwise execute the operating system boot up process as discussed earlier in step 210 of flowchart 200.

If, in step 308, device management program 110 determines that the secondary authentication measure timed out, then in step 310, device management program 110 determines whether there is sensitive data on the device. In this embodiment, device management program 110 identifies whether there is sensitive data by identifying locations of potentially sensitive data and identifying data types that are typically associated with sensitive data.

In this embodiment, database 112 can store and be accessed by device management program 110. In this embodiment database 112 contains a list of one or more sets of data types (e.g., file extensions such as .mp4, .tff, .jpeg, .pdf, etc.) that can potentially contain sensitive information regarding an individual or a set of individuals, which can include, but is not limited to, contact information (e.g., name of the individual, email address, phone number, social media identification, messaging service alias, etc.), images, audio (i.e., audio that captures the voice of the individual(s) speaking), and video recordings. As an example, among database 112 are a set of files stored in a SQLite3 file format (i.e., “.db”) that lists contact information of a set of individuals, a set of audio files with extension “.mp3” and “.mp4”, and a set of video files with extension “.avi”. Device management program 110 can identify from database 112 that the device has extensions “.db”, “.mp3”, “.mp4”, and “.avi” and that those file extensions are potentially sensitive data types. Device management program 110 can then identify the locations of potentially sensitive data by scanning database 112 for files having extensions “.db”, “.mp3”, “.mp4”, or “.avi”, matching a set of files having the aforementioned extensions, and identifying a set of storage location addresses corresponding to the matched set of files.

In step 312, device management program 110 can then encrypt the sensitive data. In this embodiment, device management program 110 encrypts the identified sensitive data using any encryption method known in the art.

Accordingly, by performing the operational steps of flowchart 300, embodiments of the present invention can help validate hardware components offline, that is, without requiring a connection to a network or requiring one or more services hosted on a server. In this manner, embodiments of the present invention improves current security measures for computing devices in the event the computing device is lost by validating hardware components, such as batteries, that could be replaced in order to circumvent traditional security measures.

FIG. 4 depicts a block diagram of components of computing systems within computing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computer system 400 includes communications fabric 402, which provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 708 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Device management program 110 (not shown) may be stored in persistent storage 408 and in memory 706 for execution by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Device management program 110 may be downloaded to persistent storage 408 through communications unit 410.

I/O interface(s) 412 allows for input and output of data with other devices that may be connected to client computing device and/or server computer 108. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., device management program 110, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving a request to boot up an operating system of a computing device;
determining whether a hardware component of the computing device is valid; and
in response to determining that the hardware component of the computing device is not valid, performing one or more security measures.

2. The computer-implemented method of claim 1, wherein determining whether a hardware component of the computing device is valid comprises:
identifying a serial number associated with the hardware component; and
determining whether the identified serial number associated with the hardware component matches a registered number with the computing device.

3. The computer-implemented method of claim 2, further comprising:
in response to determining that the identified serial number associated with the hardware component does not match a registered number with the computing device, providing an authentication measure via the computing device; and
in response to receiving an input that fails the authentication measure, preventing boot up of the operating system of the computing device.

4. The computer-implemented method of claim 3, wherein the input that fails the authentication measure is an incorrect password or meets an authentication time out period.

5. The computer-implemented method of claim 3, further comprising:
determining data contained on the computing device is sensitive; and
in response to determining that there is sensitive data on the computing device, encrypting the sensitive data.

6. The computer-implemented method of claim 1, wherein performing one or more security measures comprises:
preventing access to one or more ports operatively connected to the hardware component that was determined to be not valid.

7. The computer-implemented method of claim 1, further comprising:
in response to determining that the hardware component of the computing device is not valid, marking a current location of the computing device; and
transmitting the marked current location of the computing device to a registered user associated with the computing device.

8. The computer-implemented method of claim 2, wherein determining whether a hardware component of the computing device is valid occurs offline.

9. A computer program product comprising:
one or more computer readable storage media and program instructions stored on the one or more computer readable storage media, the program instructions comprising:
program instructions to receive a request to boot up an operating system of a computing device;
program instructions to determine whether a hardware component of the computing device is valid; and
program instructions to, in response to determining that the hardware component of the computing device is not valid, perform one or more security measures.

10. The computer program product of claim 9, wherein the program instructions to determine whether a hardware component of the computing device is valid comprise:
program instructions to identify a serial number associated with the hardware component; and
program instructions to determine whether the identified serial number associated with the hardware component matches a registered number with the computing device.

11. The computer program product of claim 10, wherein the program instructions stored on the one or more computer readable storage media further comprise:
program instructions to, in response to determining that the identified serial number associated with the hardware component does not match a registered number with the computing device, provide an authentication measure via the computing device; and
program instructions to, in response to receiving an input that fails the authentication measure, prevent boot up of the operating system of the computing device.

12. The computer program product of claim 11, wherein the input that fails the authentication measure is an incorrect password or meets an authentication time out period.

13. The computer program product of claim 11, wherein the program instructions stored on the one or more computer readable storage media further comprise:
program instructions to determine data contained on the computing device is sensitive; and
program instructions to, in response to determining that there is sensitive data on the computing device, encrypt the sensitive data.

14. The computer program product of claim 9, wherein the program instructions to perform one or more security measures comprise:
program instructions to prevent access to one or more ports operatively connected to the hardware component that was determined to be not valid.

15. A computer system comprising:
one or more computer processors;
one or more computer readable storage media; and
program instructions stored on the one or more computer readable storage media for execution by at least one of the one or more computer processors, the program instructions comprising:
program instructions to receive a request to boot up an operating system of a computing device;
program instructions to determine whether a hardware component of the computing device is valid; and
program instructions to, in response to determining that the hardware component of the computing device is not valid, perform one or more security measures.

16. The computer system of claim 15, wherein the program instructions to determine whether a hardware component of the computing device is valid comprise:
program instructions to identify a serial number associated with the hardware component; and
program instructions to determine whether the identified serial number associated with the hardware component matches a registered number with the computing device.

17. The computer system of claim 16, wherein the program instructions stored on the one or more computer readable storage media further comprise:
program instructions to, in response to determining that the identified serial number associated with the hardware component does not match a registered number with the computing device, provide an authentication measure via the computing device; and
program instructions to, in response to receiving an input that fails the authentication measure, prevent boot up of the operating system of the computing device.

18. The computer system of claim 17, wherein the input that fails the authentication measure is an incorrect password or meets an authentication time out period.

19. The computer system of claim 17, wherein the program instructions stored on the one or more computer readable storage media further comprise:
program instructions to determine data contained on the computing device is sensitive; and
program instructions to, in response to determining that there is sensitive data on the computing device, encrypt the sensitive data.

20. The computer system of claim 15, wherein the program instructions to perform one or more security measures comprise:
program instructions to prevent access to one or more ports operatively connected to the hardware component that was determined to be not valid.
